(19) United States
(12) Patent Application Publication
(10) Pub. No.: US 2017/0326908 A1
(43) Pub. Date: Nov. 16, 2017

(54) DISPOSABLE CONTAINER FOR COATING APPLICATORS

(71) Applicant: Dustin Martin, Clarkston, MI (US)

(72) Inventor: Dustin Martin, Clarkston, MI (US)

(21) Appl. No.: 15/602,200

(22) Filed: May 23, 2017

Related U.S. Application Data
(63) Continuation-in-part of application No. 15/154,432, filed on May 13, 2016, now abandoned.

(51) Int. Cl. B44D 3/12; A46B 17/04; B65D 75/30; B65D 75/58

(52) U.S. Cl. CPC B44D 3/125; B65D 75/5827; A46B 17/04; B65D 75/30

(57) ABSTRACT

A container for a paint applicator and a method for using same is disclosed herein. The container comprises: a first layer having a top edge, opposing sidewalls, and a bottom edge; and a second layer having a top edge, opposing sidewalls, and a bottom edge. The sidewalls of the first and second layers being sealed together and the bottom edges being partially sealed to form a rupturable seam having an aperture formed therein. The sidewalls, bottom edge, and top edge defining an enclosed interior for stowing a paint applicator. The applicator is stowable within the container by inserting the applicator through the top end and projecting a handle thereof through the aperture. Upon pulling the handle through the aperture, the seam ruptures, thereby allowing the applicator to be removed from the container.

### CROSS-REFERENCE TO RELATED APPLICATION

The application is a continuation-in-part application of co-pending U.S. Non-Provisional patent application Ser. No. 15/154,432, filed May 13, 2016, for “Disposable Container for Coating Applicators,” which claims the priority benefit of U.S. Provisional Patent Application No. 62/160,820, filed May 13, 2015, the disclosures of which are hereby incorporated by reference in their entirety, including the drawings.

### BACKGROUND OF THE INVENTION

### 1. Field of the Invention

The present invention pertains to containers for coating applicators, such as paint brushes and paint rollers. More particularly, the present invention pertains to disposable containers for removably stowing such applicators having paint thereon. Even more particularly, the present invention concerns methods for stowing and removing paint applicators from said disposable containers.

### 2. Prior Art

The prior art has taught many types of packaging and/or containers for paint applicators, such as paint brushes and paint rollers, whether new or used. One of the more challenging issues with such paint applicators is the temporary stowage for later use after the applicator has been used to apply paint. Thus, stowing paint brushes and paint rollers for later use and which have already been used creates a significant stowage issue. One can clean the brush or the roller prior to stowing which is a messy and cumbersome job. Alternatively, one can simply throw away the applicator and start the next job with a fresh one. Either one of these situations is not ideal.

Thus, the prior art has attempted to solve some of these issues. For example, U.S. Patent Publication No. 2005/0145518 discloses a container having a re-sealable top with an opening in the bottom for protecting a handle therethrough. The applicator is inserted through the top of the container and the handle is projected through the opening in the bottom. The opening is then taped to seal off the bottom. Removal of the brush or roller from the container for subsequent re-use of the applicator involves opening the container and folding it back upon itself so that the applicator is exposed. However, such a device becomes cumbersome because one still needs to manipulate the container, itself.

Yet another device is shown in U.S. Pat. No. 7,111,354 where an openable container stows a paint brush or paint roller that is positionable in a first position to close off the cover and in a second position to expose the applicator. However, it is intended that the applicator remains with the container at all times.

Other packaging devices are shown in the prior art such as, for example, U.S. Pat. Nos. 4,967,508 and 7,537,111.

It becomes apparent from the prior art that there is a need for a disposable cover, container, or package which removably stows a paint applicator having paint thereon, but which provides readily available access to the applicator without the need for keeping the container in association with an applicator. It is to this to which the present invention is directed.

### SUMMARY OF THE INVENTION

In accordance with a first aspect of the present invention, there is provided a disposable container for stowing a paint applicator. The container hereof comprises:
(a) a first layer having a top edge, a pair of opposing sidewalls, and a bottom edge, the bottom edge having a semi-circular opening formed therein;
(b) a second layer having a top edge, a pair of opposing sidewalls, and a bottom edge, the bottom edge having a semi-circular opening formed therein;
wherein the bottom edge of the first and second layers are partially sealed together on opposing sides of the semi-circular openings to form a rupturable seam and respective sidewalls of the first and second layers are sealed together, thereby defining an open interior within the container; and
further wherein the semi-circular openings are coincident to form an aperture for receiving a handle of a paint applicator, the aperture intersecting the seam at diametrically opposed termini, each terminus tangentially intersecting the seam substantially perpendicular thereto.

The semi-circular openings formed in the bottom edge of the first and second layers facilitate the rupturing of the seam. Thus, an applicator stowed within the container may be removed by pulling the handle through the aperture and rupturing the seam due to the weakness of the seam.

In accordance with a second aspect hereof, there is provided a method for stowing and, thereafter, removing a paint applicator from a disposable container, as described above. The method comprises the steps of:
(a) providing a container having a top edge, opposing sidewalls, and a partially sealed bottom edge, the bottom edge defining a rupturable seam having an aperture formed therein;
(b) stowing a paint applicator within the container, the applicator having a handle extending through the aperture in the bottom edge; and
(c) pulling the handle through the aperture, thereby rupturing the seam and removing the applicator from the container.

For a more complete understanding of the present invention, reference is made to the following detailed description and accompanying drawing in which:

### BRIEF DESCRIPTION OF THE DRAWINGS

FIG. 1 is a plan view of a container in accordance with the present invention with opposing sidewalls thereof not sealed;

FIG. 2 is a plan view of the container hereof having sealed sidewalls and a paint applicator disposed therein;

FIG. 3 is a perspective view of the container as shown in FIG. 2 with the paint applicator disposed therein.

FIGS. 4A-F is a plan view of the container hereof depicting the paint applicator removal sequence from the container;

FIG. 5 is a perspective view of the container hereof in conjunction with a paint roller;

FIG. 6 is a plan view showing the deployment of the container hereof in stowing the paint roller.

### DETAILED DESCRIPTION OF THE INVENTION

As noted hereinabove, the present invention provides a container for stowing a paint applicator. The container, generally, comprises:
(a) a first layer having a top edge, a pair of opposing sidewalls, and a bottom edge, the bottom edge having a semi-circular opening formed therein;
(b) a second layer having a top edge, a pair of opposing sidewalls, and a bottom edge, the bottom edge having a semi-circular opening formed therein;
wherein the bottom edge of the first and second layers are partially sealed together on opposing sides of the semi-circular openings to form a rupturable seam and respective sidewalls of the first and second layers are sealed together, thereby defining an open interior within the container; and
further wherein the semi-circular openings are coincident with each other to form an aperture for receiving a handle of a paint applicator, the aperture intersecting the seam at diametrically opposed termini, each terminus tangentially intersecting the seam substantially perpendicular thereto.

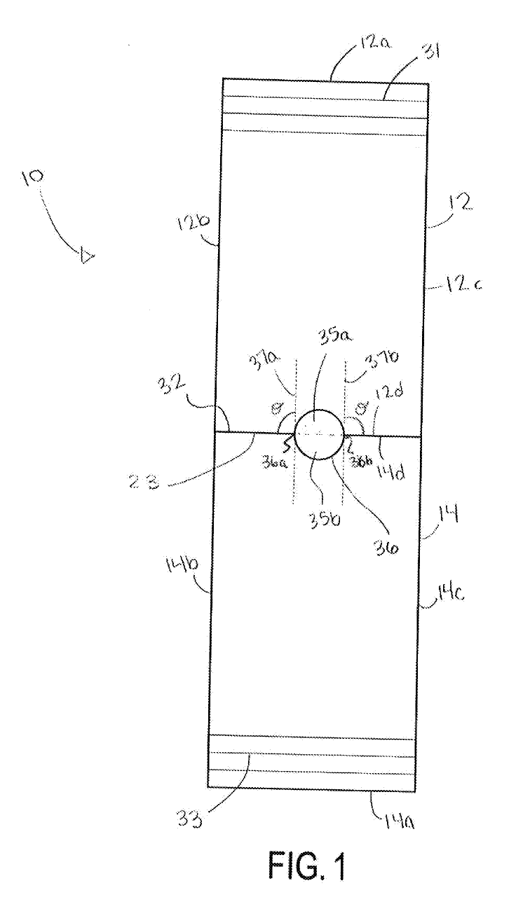

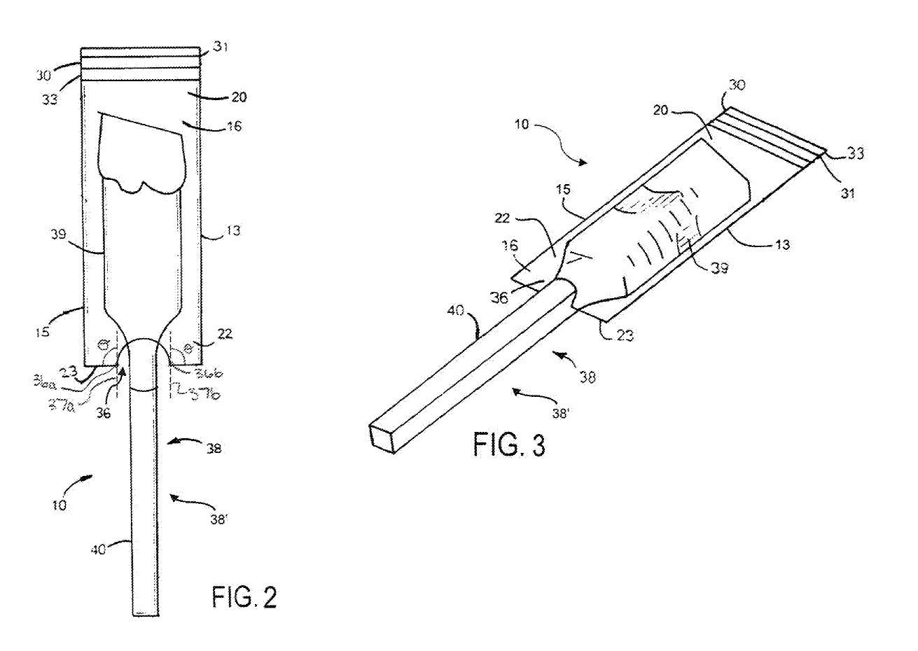

Now, and with reference to the drawing, and in particular FIGS. 1-4, there is depicted therein a disposable container, generally, denoted at 10 for removably stowing a paint applicator 38. As shown in FIGS. 2-4, the paint applicator 38 is a paint brush 38′ having a plurality of bristles 39 and a handle 40 extending therefrom.

As shown in the drawing, the container 10 comprises a thin film packaging material having a first layer 12 and a second layer 14. Preferably, the first and second layers 12, 14 are formed from a thin film plastic having a thickness of about 2 mil or less.

With more particularity and as shown in FIG. 1, the container 10 is shown in a partially assembled form. The first and second layers 12, 14 each include a top edge 12a, 14a, a pair of opposing sidewalls 12b, 12c, 14b, 14c, and a bottom edge 12d, 14d, respectively. The container 10 further includes a rupturable seam 23 formed by partially sealing the bottom edges 12d, 14d together.

The bottom edges 12d, 14d each include a semi-circular opening 35a, 35b, respectively, formed at a medial portion of the seam 23. Each semi-circular opening 35a, 35b has, by definition, a uniform radius throughout. In an at least partially assembled form, as shown in FIG. 1, the semi-circular openings 35a, 35b align with each other to form an aperture 36.

The semi-circular openings 35a, 35b may be individually formed by die cutting the layers 12, 14 prior to sealing the bottom edges 12d, 14d.

Alternatively, the aperture 36 may be die cut into the container 10 as a whole after sealing at least the bottom edges 12d, 14d.

What is critical hereto is that the aperture 36 intersects the seam 23 at diametrically opposed termini shown at 36a, 36b which form tangent lines 37a, 37b, each terminus 36a, 36b tangentially intersecting the seam 23 substantially perpendicular thereto. As shown in FIGS. 1 and 2, the tangent lines 37a, 37b are substantially perpendicular to the seam 23. Preferably, the angle of intersection is 90 degrees, as shown by Θ.

It is to be understood that the combination of the first and second layers 12, 14 being formed from a thin film plastic and the aperture 36 having diametrically opposed termini 36a, 36b which intersect the seam 23 at a substantially perpendicular angle allow the seam 23 to be rupturable as force is applied parallel to the tangent lines 37a, 37b .

Other configurations will have an adverse effect on the rupturability of the seam 23. For example, an elliptical opening having edges intersecting the seam 23 at an angle greater than 90 degrees will cause the seam 23 to be too weak and rupture too easily. Alternatively, where the edges of the aperture 36 are angled toward the center of the seam 23 and intersect the seam 23 at an angle less than 90 degrees, the seam 23 will not be weak enough.

As shown in FIGS. 2 and 3, the container 10 includes sidewalls 13, 15, a top portion 20, and a bottom portion 22 which cooperate with one another to define an open interior 16. The paint brush 38′, having bristles 39 and a handle 40, may then be inserted into the interior 16 of the container 10 through the open top portion 20. In doing so, the handle 40 of the brush 38′ projects through the aperture 36, formed by semi-circular openings 35a, 35b which are coincident or align with each other, provided in the bottom portion 22.

Preferably, the top portion 20 of the container 10 is provided with means for resealing 30 of the type which is well known and commercially available, wherein one layer has a track 31 and the other layer has an embossment 33, which sealingly fits within the track 31. Thus, the container 10 is resealable along the top portion 20.

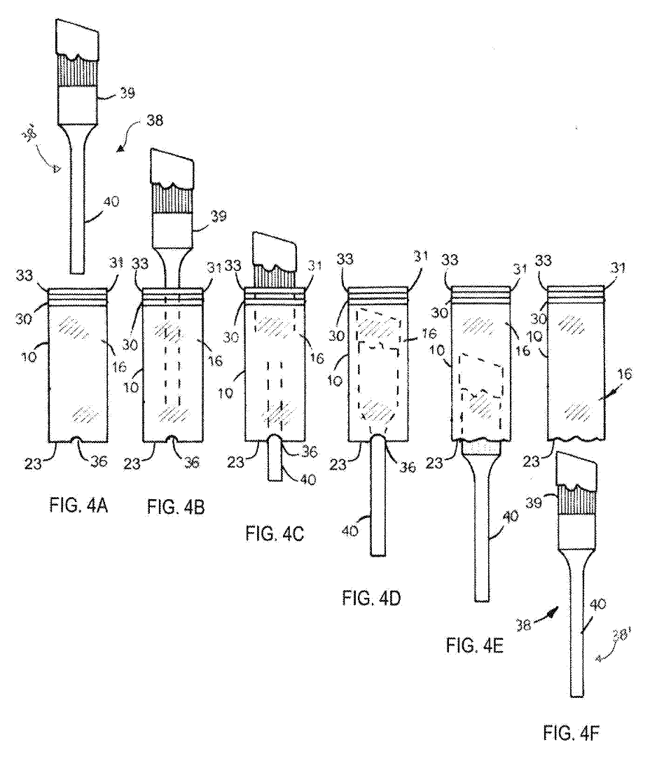

Referring to FIG. 4, and in accordance with a second aspect hereof, the present invention provides a method for removably stowing a paint applicator within the container 10. The method comprises the steps of:
(a) providing the container 10;
(b) stowing the paint applicator 38 within the container 10, the handle 40 extending through the aperture 36 in the seam 23; and
(c) removing the applicator 38 from the container 10 by pulling the handle 40 through the aperture 36, thereby rupturing the seam 23.

Prior to removing the applicator 38 from the container, the top portion 20 may be sealed in a conventional manner by urging the embossment 33 into the track 31. This prevents wet paint from dripping off of the applicator 38 and out of the container 10.

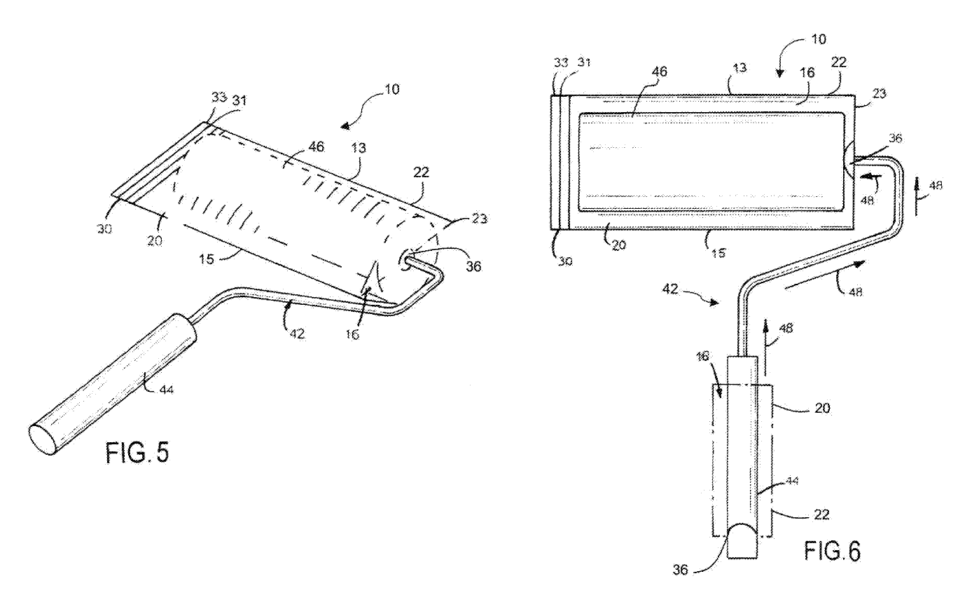

Referring now to FIGS. 5 and 6, as shown, the applicator 38 is a paint roller 42 having a handle 44 and a roller head 46. In use with the roller 42, the container 10 is first emplaced over the handle 44 thereof. Thereafter, the container 10 is translated or moved toward the roller head 46, as shown by arrows 48. As the container 10 approaches the roller head 46, it is opened, slid thereover. Thereafter, the top portion 20 may be sealed.

To re-use the roller 42, the top portion 20 of the container 10 is grasped and the handle 44 of the roller 42 is pulled toward the rupturable bottom seam 23. Because of its weakness, the bottom seam 23 readily ruptures and bursts, thereby removing the roller 42 from the container 10 and enabling the roller 42 to be re-used.

Thereafter, the container 10, itself, having residual paint therewithin is easily disposed of or discarded.

From the above, it is to be appreciated that defined herein is a new and unique container which provides an easier and cleaner method for stowing a paint applicator such as a paint brush or paint roller.

### REFERENCE NUMERALS

10 Container
12 First layer
12a Top edge of first layer
12b Sidewall of first layer
12c Sidewall of first layer
12d Bottom edge of first layer
13 Sidewall of container
14 Second layer
14a Top edge of second layer
14b Sidewall of second layer
14c Sidewall of second layer
14d Bottom edge of second layer
15 Sidewall of container
16 Open interior of container
20 Top portion of container
22 Bottom portion of container
23 Seam
30 Means for resealing
31 Track
33 Embossment
35a Semi-circular opening in first layer
35b Semi-circular opening in second layer
36 Aperture
36a Terminus of aperture
36b Terminus of aperture
37a Tangent line
37b Tangent line
38 Paint applicator
38′ Paint brush
39 Bristles of applicator
40 Handle of applicator
42 Paint roller
44 Handle of paint roller
46 Roller head of paint roller
48 Arrows

Having, thus, described the invention, what is claimed is:

1. A container for stowing a paint applicator, comprising:
(a) a first layer having a top edge, a pair of opposing sidewalls, and a bottom edge, the bottom edge having a semi-circular opening formed therein;
(b) a second layer having a top edge, a pair of opposing sidewalls, and a bottom edge, the bottom edge having a semi-circular opening formed therein;
wherein the bottom edge of the first and second layers are partially sealed together on opposing sides of the semi-circular openings to form a rupturable seam and respective sidewalls of the first and second layers are sealed together, thereby defining an open interior within the container; and
further wherein the semi-circular openings are coincident with each other to form an aperture for receiving a handle of a paint applicator, the aperture intersecting the seam at diametrically opposed termini, each terminus tangentially intersecting the seam substantially perpendicular thereto.

2. The applicator of claim 1 wherein each of the films is formed from a thin film plastic.

3. The applicator of claim 2 wherein the thin film has a thickness of less than about 2 mm.

4. The applicator of claim 3, further comprising:
(a) a track formed proximate the top edge of the first layer;
(b) an embossment formed proximate the top edge of the second layer, the embossment being fitable in the track to seal the container.

5. The applicator of claim 1 wherein the rupturable seal extends from the aperture to respective sidewalls of the container.

6. A method for removably stowing a paint applicator within a container, the method comprising the steps of:
(a) providing a container having a resealable top edge and a partially sealed bottom edge defining a rupturable seam having an aperture formed therein;
(b) stowing a paint applicator in the container, the applicator having a handle extending through the aperture in the seam; and
(c) pulling the handle through the aperture, thereby rupturing the seam and removing the applicator from the container.

7. The method of claim 6, further comprising:
sealing the top edge of the container once the paint applicator is stowed therein.
